(19) United States
(12) Patent Application Publication
(10) Pub. No.: US 2025/0295151 A1
(43) Pub. Date: Sep. 25, 2025

(54) PREPARATION METHOD OF COMPOUND TOTAL-NUTRIENT AND HEALTHY DRIED PASSIFLORA EDULIS SIMS

(71) Applicant: AORAW INC, JURUPA VALLEY, CA (US)

(72) Inventors: FENG YAO, JURUPA VALLEY, CA (US); XIAOYAN CHEN, JURUPA VALLEY, CA (US); JIANG CHEN, JURUPA VALLEY, CA (US); JIN CHEN, JURUPA VALLEY, CA (US)

(21) Appl. No.: 18/619,336

(22) Filed: Mar. 28, 2024

(30) Foreign Application Priority Data
Mar. 21, 2024 (CN) 202410329934.3

(51) Int. Cl. A23L 19/00; A23L 5/20; A23L 33/125; A23P 30/10

(52) U.S. Cl. CPC A23L 19/09; A23L 5/20; A23L 33/125; A23P 30/10

(57) ABSTRACT

The present invention discloses a preparation method of compound total-nutrient and healthy dried Passiflora edulis Sims, comprising: (1) selecting fruit; (2) cleaning, digging a fruit pulp, and removing a fruit peel; (3) pressing the fruit pulp; (4) crushing the flesh; (5) mixing the Passiflora edulis Sims juice, the Passiflora edulis Sims slurry, liquid sugar or powdered sugar or high fructose syrup, apple juice or grape juice or lemon juice, adding citric acid and stirring; (6) pouring the Passiflora edulis Sims composite slurry into a mold, drying, removing the mold, sprinkling fine powdered sugar, and packaging to obtain dried Passiflora edulis Sims. The dried Passiflora edulis Sims in the present invention has aromatic flavor, good taste, sweet and sour taste, comprehensive and balanced nutrition, long shelf life, convenience in eating and suitability for all kinds of people to eat.

### TECHNICAL FIELD

The present invention relates to the technical field of food processing, and in particular to a preparation method of compound total-nutrient and healthy dried Passiflora edulis Sims.

### BACKGROUND

Passiflora edulis Sims is native to South America, with a scientific name of passion fruit, and its flesh can emit dozens of fruit aroma. Passiflora edulis Sims contains 17 kinds of amino acids, and has unique taste and high nutritional value.

After the fresh fruit of Passiflora edulis Sims is picked, the physiological activities of Passiflora edulis Sims are vigorous under the influence of high temperature, and it is also susceptible to infection by various microorganisms, so the fruit is easy to deteriorate and rot after picked, and loses the original color, aroma and taste, thereby bringing great difficulties to storage, transportation and preservation.

At present, the traditional drying and processing method of Passiflora edulis Sims slices has the problems of poor taste, unbalanced nutrition and different appearances and sizes of dried Passiflora edulis Sims, and also has many defects such as industrial additives.

Therefore, how to prepare a dried Passiflora edulis Sims with excellent sensory effect and nutritional value is an urgent problem for those skilled in the art.

### SUMMARY

In view of this, a purpose of the present invention is to provide a preparation method of compound total-nutrient and healthy dried Passiflora edulis Sims to solve the shortcomings in the prior art.

In order to achieve the above purpose, the present invention adopts the following technical solution:

A preparation method of compound total-nutrient and healthy dried Passiflora edulis Sims specifically comprises the following steps:
(1) selecting fresh, no-rot, no-pest, no-disease spot and fully Passiflora edulis Sims fruit as preparation raw material;
(2) cleaning the Passiflora edulis Sims fruit, digging a fruit pulp, and removing a fruit peel to obtain the fruit pulp and flesh;
(3) pressing the fruit pulp to obtain Passiflora edulis Sims juice;
(4) crushing the flesh to obtain Passiflora edulis Sims slurry;
(5) uniformly mixing the Passiflora edulis Sims juice, the Passiflora edulis Sims slurry, liquid sugar or powdered sugar or high fructose syrup, apple juice or grape juice or lemon juice (or adding other juices according to taste and nutritional ratio) in a certain ratio, adding citric acid as needed to adjust a pH value, and stirring evenly to obtain Passiflora edulis Sims composite slurry;
(6) pouring the Passiflora edulis Sims composite slurry into a mold, drying, removing the mold, sprinkling fine powdered sugar, and packaging to obtain dried Passiflora edulis Sims.

In the present invention, the Passiflora edulis Sims juice and the Passiflora edulis Sims slurry can contain a certain proportion of Passiflora edulis Sims seeds.

Further, in above step (5), the citric acid is added to the Passiflora edulis Sims composite slurry at a pH of 2.5-7.0.

Further, in above step (6), the mold is a stainless steel plate or a plastic plate.

Further, the stainless steel plate is provided with a plurality of round holes with a diameter of 0.2-10 cm or cartoon shapes. The surface of the stainless steel plate should be smooth, and the cut surfaces of the drilled round holes should be neat. If there are technical conditions, laser cutting, water drill, etc. can be used to obtain cartoon fancy molds such as star shapes or animal shapes.

Further, the plastic plate is made of tetrafluoroethylene.

Further, in above step (6), drying temperature is 50-95° C. until the water content of the dried Passiflora edulis Sims is 10%-20%.

Further, in above step (6), the use amount of the fine powdered sugar is 1%-3% of the mass of the dried Passiflora edulis Sims to separate the dried Passiflora edulis Sims.

Further, in above step (6), the packaging material is an aluminum-plastic (PE) composite bag to avoid moisture regain.

According to the above technical solution, compared with the prior art, the present invention has the following beneficial effects:

1. The present invention adopts all natural raw materials, and the dried Passiflora edulis Sims prepared by the present invention has aromatic flavor, good taste, sweet and sour taste, comprehensive and balanced nutrition, long shelf life, convenience in eating and suitability for all kinds of people to eat.

2. The preparation method of the present invention can completely retain the nutritional components of Passiflora edulis Sims, adjust the taste according to needs, have uniform and beautiful shape, convenience in eating, good taste, strong Passiflora edulis Sims flavor and suitability for all kinds of people to eat.

3. The drying method of the present invention is not only applicable to Passiflora edulis Sims, but also applicable to other fruits such as apples, bananas, pears and pineapples.

### DETAILED DESCRIPTION

Technical solutions in the embodiments of the present invention are described clearly and fully below. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

A preparation method of compound total-nutrient and healthy dried Passiflora edulis Sims specifically comprises the following steps:
(1) selecting fresh, no-rot, no-pest, no-disease spot and fully Passiflora edulis Sims fruit as preparation raw material;
(2) cleaning the Passiflora edulis Sims fruit, digging a fruit pulp, and removing a fruit peel to obtain the fruit pulp and flesh;
(3) pressing the fruit pulp to obtain Passiflora edulis Sims juice;
(4) crushing the flesh to obtain Passiflora edulis Sims slurry;
(5) uniformly mixing the Passiflora edulis Sims juice, the Passiflora edulis Sims slurry, liquid sugar, high fructose syrup, apple juice, grape juice and lemon juice in a mass ratio of 80:20:5:3:2:2:2, then adding citric acid until the pH is 2.5, and stirring evenly to obtain Passiflora edulis Sims composite slurry;
(6) pouring the Passiflora edulis Sims composite slurry into a stainless steel plate mold with 100 round holes with a diameter of 0.2 cm, drying at 50° C. until the water content is 20%, removing the mold, sprinkling 1% of fine powdered sugar, and packaging with an aluminum-plastic composite bag to obtain dried Passiflora edulis Sims.

### Embodiment 2

A preparation method of compound total-nutrient and healthy dried Passiflora edulis Sims specifically comprises the following steps:
(1) selecting fresh, no-rot, no-pest, no-disease spot and fully Passiflora edulis Sims fruit as preparation raw material;
(2) cleaning the Passiflora edulis Sims fruit, digging a fruit pulp, and removing a fruit peel to obtain the fruit pulp and flesh;
(3) pressing the fruit pulp to obtain Passiflora edulis Sims juice;
(4) crushing the flesh to obtain Passiflora edulis Sims slurry;
(5) uniformly mixing the Passiflora edulis Sims juice, the Passiflora edulis Sims slurry, liquid sugar, high fructose syrup, apple juice, grape juice and lemon juice in a mass ratio of 50:50:5:3:2:2:2, then adding citric acid until the pH is 6.0, and stirring evenly to obtain Passiflora edulis Sims composite slurry;
(6) pouring the Passiflora edulis Sims composite slurry into a stainless steel plate mold with 100 round holes with a diameter of 5 cm, drying at 80° C. until the water content is 15%, removing the mold, sprinkling 2% of fine powdered sugar, and packaging with an aluminum-plastic composite bag to obtain dried Passiflora edulis Sims.

### Embodiment 3

A preparation method of compound total-nutrient and healthy dried Passiflora edulis Sims specifically comprises the following steps:
(1) selecting fresh, no-rot, no-pest, no-disease spot and fully Passiflora edulis Sims fruit as preparation raw material;
(2) cleaning the Passiflora edulis Sims fruit, digging a fruit pulp, and removing a fruit peel to obtain the fruit pulp and flesh;
(3) pressing the fruit pulp to obtain Passiflora edulis Sims juice;
(4) crushing the flesh to obtain Passiflora edulis Sims slurry;
(5) uniformly mixing the Passiflora edulis Sims juice, the Passiflora edulis Sims slurry, powdered sugar, high fructose syrup, apple juice, grape juice and lemon juice in a mass ratio of 20:80:5:3:2:2:2, then adding citric acid until the pH is 7.0, and stirring evenly to obtain Passiflora edulis Sims composite slurry;
(6) pouring the Passiflora edulis Sims composite slurry into a stainless steel plate mold with 100 round holes with a diameter of 10 cm, drying at 95° C. until the water content is 10%, removing the mold, sprinkling 3% of fine powdered sugar, and packaging with an aluminum-plastic composite bag to obtain dried Passiflora edulis Sims.

### Performance Test

The dried Passiflora edulis Sims prepared in each of embodiments 1-3 is taken, and a commercially available dried Passiflora edulis Sims is used as a control group to conduct sensory detection and physical and chemical index detection respectively.

### 1. Sensory Detection

The scoring standards are shown in Table 1, and test results are shown in Table 2.

TABLE 1
Scoring Standards for Sensory Detection

| Test item | Judging standard | Score |
|---|---|---|
| Color | Reddish brown, glossy, and good transparency | 25 |
| Flavor | Sweet and delicious, with a strong Passiflora edulis | 25 |
| | Sims flavor, no burnt taste or other odor | |
| Texture | Full tissue, neat sheet shape, smooth surface and no | 25 |
| | permeated sugar outside or sugar flow phenomenon | |
| Taste | Moderate hardness, elasticity and certain chewing, | 25 |
| | withnot sticking teeth | |

TABLE 2
Test Results of Sensory Detection

| | | | | Control |
|---|---|---|---|---|
| Group | Embodiment 1 | Embodiment 2 | Embodiment 3 | group |
| Total score | 96 | 98 | 95 | 82 |

It can be seen from Table 2 that compared with the control group, the sensory scores of the dried Passiflora edulis Sims in embodiments 1-3 of the present invention are significantly increased.

### 2. Physical and Chemical Index Detection

Test results are shown in Table 3.

TABLE 3
Test Results of Physical and Chemical Indexes

| | Total | Total | Vitamin | Crude | |
|---|---|---|---|---|---|
| Group | sugar/% | acid/% | C/mg/kg | protein/% | Water/% |
| Mean value of | 22.5 | 0.26 | 51.6 | 18.2 | 10.4 |
| embodiments 1-3 | | | | | |
| Control group | 36.8 | 0.34 | 20.8 | 14.3 | 9.7 |

It can be seen from Table 3 that compared with the control group, the content of total sugar and the content of total acid in the dried Passiflora edulis Sims in embodiments 1-3 of the present invention are significantly reduced, and the content of vitamin C and the content of crude protein are significantly increased.

The above test indicates that the present invention adopts all natural raw materials, and the dried Passiflora edulis Sims prepared by the present invention has aromatic flavor, good taste, sweet and sour taste, comprehensive and balanced nutrition, long shelf life, convenience in eating and suitability for all kinds of people to eat.

The above description of the disclosed embodiments enables those skilled in the art to realize or use the present invention. Many modifications made to these embodiments will be apparent to those skilled in the art. General principles defined herein can be realized in other embodiments without departing from the spirit or scope of the present invention. Therefore, the present invention will not be limited to these embodiments shown herein, but will conform to the widest scope consistent with the principles and novel features disclosed herein.

What is claimed is:

1. A preparation method of compound total-nutrient and healthy dried Passiflora edulis Sims, specifically comprising the following steps:
(1) selecting fresh, no-rot, no-pest, no-disease spot and fully Passiflora edulis Sims fruit as preparation raw material;
(2) cleaning the Passiflora edulis Sims fruit, digging a fruit pulp, and removing a fruit peel to obtain the fruit pulp and flesh;
(3) pressing the fruit pulp to obtain Passiflora edulis Sims juice;
(4) crushing the flesh to obtain Passiflora edulis Sims slurry;
(5) uniformly mixing the Passiflora edulis Sims juice, the Passiflora edulis Sims slurry, liquid sugar or powdered sugar or high fructose syrup, apple juice or grape juice or lemon juice in a certain ratio, adding citric acid as needed to adjust a pH value, and stirring evenly to obtain Passiflora edulis Sims composite slurry;
(6) pouring the Passiflora edulis Sims composite slurry into a mold, drying, removing the mold, sprinkling fine powdered sugar, and packaging to obtain dried Passiflora edulis Sims.

2. The preparation method of compound total-nutrient and healthy dried Passiflora edulis Sims according to claim 1, wherein in step (5), the citric acid is added to the Passiflora edulis Sims composite slurry at a pH of 2.5-7.0.

3. The preparation method of compound total-nutrient and healthy dried Passiflora edulis Sims according to claim 1, wherein in step (6), the mold is a stainless steel plate or a plastic plate.

4. The preparation method of compound total-nutrient and healthy dried Passiflora edulis Sims according to claim 3, wherein the stainless steel plate is provided with a plurality of round holes with a diameter of 0.2-10 cm or cartoon shapes.

5. The preparation method of compound total-nutrient and healthy dried Passiflora edulis Sims according to claim 3, wherein the plastic plate is made of tetrafluoroethylene.

6. The preparation method of compound total-nutrient and healthy dried Passiflora edulis Sims according to claim 1, wherein in step (6), drying temperature is 50-95° C. until the water content of the dried Passiflora edulis Sims is 10%-20%.

7. The preparation method of compound total-nutrient and healthy dried Passiflora edulis Sims according to claim 1, wherein in step (6), the use amount of the fine powdered sugar is 1%-3% of the mass of the dried Passiflora edulis Sims.

8. The preparation method of compound total-nutrient and healthy dried Passiflora edulis Sims according to claim 1, wherein in step (6), the packaging material is an aluminum-plastic composite bag.
